(19) United States
(12) Patent Application Publication
(10) Pub. No.: US 2011/0251750 A1
(43) Pub. Date: Oct. 13, 2011

(54) VEHICLE EMISSION MANAGER AND CREDITS BANK

(75) Inventors: Stanley W. Fields, Lake Oswego, OR (US); Brian Cash, Sisters, OR (US); Kathleen P. Eymann, Bandon, OR (US)

(73) Assignee: Climate Clean, Inc., Portland, OR (US)

(21) Appl. No.: 12/759,497

(22) Filed: Apr. 13, 2010

(51) Int. Cl. G06F 7/00

(52) U.S. Cl. 701/32; 701/29

(57) ABSTRACT

Embodiments of the present invention provide for systems, apparatuses, and methods for use in determining greenhouse gas emissions from a particular vehicle and managing associated emission reduction credits. Other embodiments may be described and claimed.

### TECHNICAL FIELD

Embodiments of the present invention relate to the field of greenhouse gas emissions and, in particular, to a vehicle emission manager and credits bank.

### BACKGROUND

Greenhouse gas (GHG) emissions from human activity is widely considered a significant contributing factor to ongoing climate change. Various compulsory and voluntary emission reduction programs have been developed throughout the world. Many of these programs are based on a premise of purchasing credits to offset a discrete amount of GHG emissions. Difficulties exist in determining the amount of GHG emissions contributed by a particular source and associating purchased credits with the source.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 illustrates a system including an emission manager in accordance with various embodiments of the present disclosure.

FIG. 2 illustrates a credits bank in accordance with various embodiments of the present disclosure.

FIG. 3 is a flowchart illustrating operations of the emission manager of FIG. 1 in accordance with various embodiments of the present disclosure.

FIG. 4 illustrates a system including a credits bank in accordance with various embodiments of the present disclosure.

FIG. 5 is a flowchart illustrating operations of the credits bank of FIG. 4 in accordance with various embodiments of the present disclosure.

FIG. 6 illustrates a computing system capable of implementing various systems, components, and/or modules in accordance with various embodiments of the present invention.

### DETAILED DESCRIPTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

For the purposes of the present invention, the phrases “A/B” and “A and/or B” mean (A), (B), or (A and B). For the purposes of the present invention, the phrase “A, B, and/or C” means (A), (B), (C), (A and B), (A and C), (B and C), or (A, B, and C). For the purposes of the present invention, the phrase “(A)B” means (B) or (A and B), that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

Embodiments of the present disclosure describe systems, methods, and apparatuses for use in determining greenhouse gas (GHG) emissions from a particular vehicle and managing associated emission reduction (ER) credits.

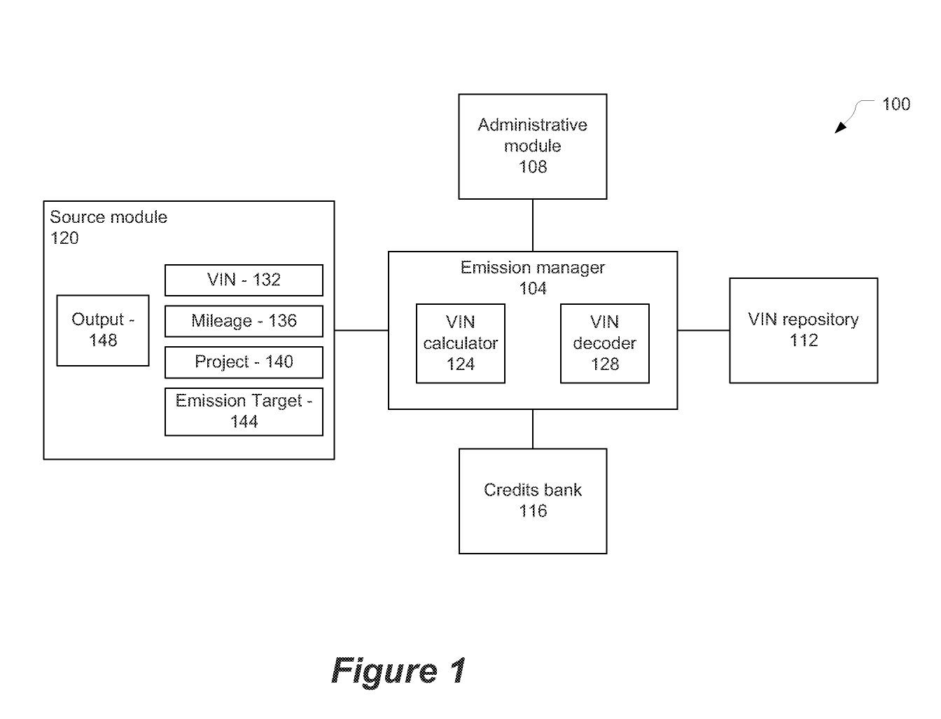

FIG. 1 illustrates a system 100 in accordance with various embodiments of the present disclosure. The system 100 includes an emission manager 104 coupled with an administrative module 108. The administrator module 108 may be used for initial configuration and subsequent maintenance and operation of the components of the system 100. The system 100 may also include a vehicle identifier number (VIN) repository 112, a credits bank 116, and a source module 120. The emission manager 104 may include a VIN calculator 124 and a VIN decoder 128.

In some embodiments, the source module 120 may be part of a dealership management system (DMS) that an automotive dealership relies upon to integrate finance, sales, and inventory operations. The source module 120 may provide input fields for receiving transactional information, from a dealer representative, related to the vehicle purchase. The input fields relevant to the emissions calculations described herein may include, but are not limited to, a VIN field 132 for receiving an identifier that uniquely identifies the vehicle, a mileage field 136 to receive an odometer reading of the vehicle, a project field 140 to receive an indication of desired ER projects from which purchased ER credits are sourced, and an emission target field 144 to receive an emission offset target, which may be a desired emission-compensated travel distance (ECTD) for the vehicle. Emission-compensated travel (ECT) may mean that emissions from a vehicle is offset in whole or in part by ER credits that are specifically allocated to the vehicle.

The ECTD may be determined in any number of ways. For example, a purchaser may indicate a desire to offset GHG emissions for a term commensurate with a term of financing of the vehicle, e.g., seven years. Based on an estimate of driving the vehicle 15,000 miles per year, the desired ECTD may be 105,000 miles in this example.

A dealer representative may enter the appropriate information (hereinafter generically referred to as “emission terms”) into the source module 120. The source module 120 may then provide the emission terms to the emission manager 104. In some embodiments, the emission terms may be provided to the emission manager 104 incrementally based on, e.g., a call and response interaction between the source module 120 and the emission manager 104.

While specific fields for the emission terms are shown in the source module 120, it may be understood that, in some embodiments, the source module 120 may extract certain terms of the emission terms from other modules of the DMS. For example, the VIN and the odometer reading may be data that is entered in DMS in the course of a standard vehicle transaction. The source module 120 may be configured to extract this data from its native module without requiring the representative to enter the information into separate fields.

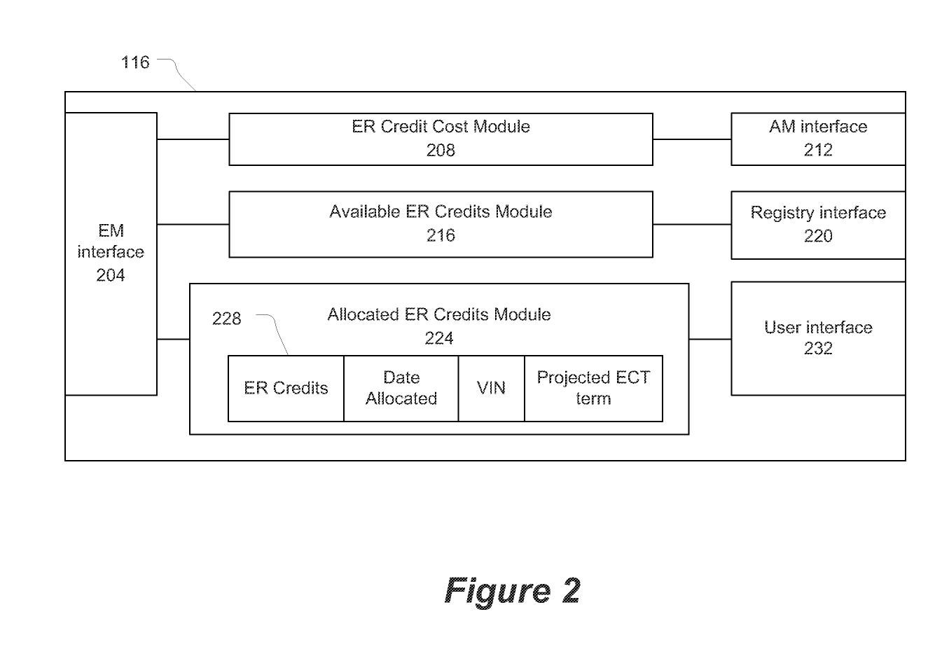

FIG. 2 illustrates the credits bank 116 in more detail in accordance with some embodiments. The credits bank 116 may include an emission manager (EM) interface 204 to communicatively couple various modules of the credits bank 116 with the emission manager 104. The credits bank 116 may include an ER credit cost module 208 that includes per-credit costs, which may include wholesale and/or retail costs, for the ER credits. These per-credit costs are typically in dollars per ton of CO2 emissions; however, they may be constructed in any suitable units. The ER credit cost module 208 may also be coupled with an administrative module (AM) interface 212 that communicatively couples the ER credit cost module 208 with the administrative module 108. This may allow the administrative module 108 to enter and/or update various costs within the ER credit cost module 208.

In some embodiments, the credits bank 116 may also include an available ER credits module 216 that includes data on non-allocated, and thus available, ER credits. The data included in the available ER credits module 216 may include source project, quantity, and type of the available ER credits. The type may provide information as to the process through which the ER credits were generated. For example, the type may be voluntary ER credits or certified ER credits, with the certified ER credits being certified and issued by a recognized regulatory body such as the United Nation's Clean Development Mechanism. The per-credit costs may differ for ER credits of different types and/or from different source projects. These different costs may be maintained in the ER credit cost module 208.

In some embodiments, data regarding the project sources of ER credits that are available may be provided to the source module 120 for population of the ER projects that are selectable through the project field 140. The ER projects selectable by the user may be a category of GHG emission reducing projects (e.g., solar, wind, geothermal, methane capture, forestry, etc.) or it may be a specific project, e.g., a methane recapture project on a dairy farm in Idaho.

The available ER credits module 216 may be coupled with a registry interface 220 that communicatively couples the available ER credits module 216 to an environmental registry. The environmental registry may provide the available ER credits module 216 with information regarding the types, project sources, and amounts of available ER credits. In some embodiments, the available ER credits module 216 may include ER credits that have been previously purchased from the environmental registry and/or ER credits that are available for purchase from the environmental registry.

In some embodiments, communication with the environmental registry may be done external to the system 100 and the appropriate information may be provided to the system 100 via the administrative module 108. Thus, at least in these embodiments, there may be no direct communication between the credits bank 116 and the environmental registry.

In some embodiments, the credits bank 116 may also include an allocated ER credits module 224 that includes records, e.g., record 228, having details of allocated ER credits. Each record may correspond to a completed transaction and may include, e.g., ER credit data (which may include amount, project source, and/or type of allocated ER credits); date the ER credits were allocated; the VIN to which the ER credits were allocated, and a projected ECT term. The allocated ER credits module 224 may be coupled with a user interface 232 to provide a user with local and/or remote access to the allocated ER credits module 224. This may provide a user with the ability to monitor, track, and verify ER credits that are allocated to a particular vehicle. In some embodiments, the allocated ER credits module 224 may receive a request, including the VIN, from a user's computing device via the user interface 232. The allocated ER credits module 224 may associate the VIN with the appropriate record and respond by providing information related to the allocated ER credits to the user's computing device via the user interface 232.

The interfaces of the credits bank 116 may be any type of interfaces appropriately designed to communicatively couple respective modules. These may be software, firmware, and/or hardware interfaces. In some embodiments, one or more of these interfaces may be, e.g., application programming interfaces configured to couple various software modules together. In some embodiments, one or more of these interfaces may be network interfaces configured to allow respective modules of the credits bank 116 to communicate over a computer network. Furthermore, while several different interfaces are shown and described with respective operations, in other embodiments a single interface may replace operations from a plurality of the interfaces shown.

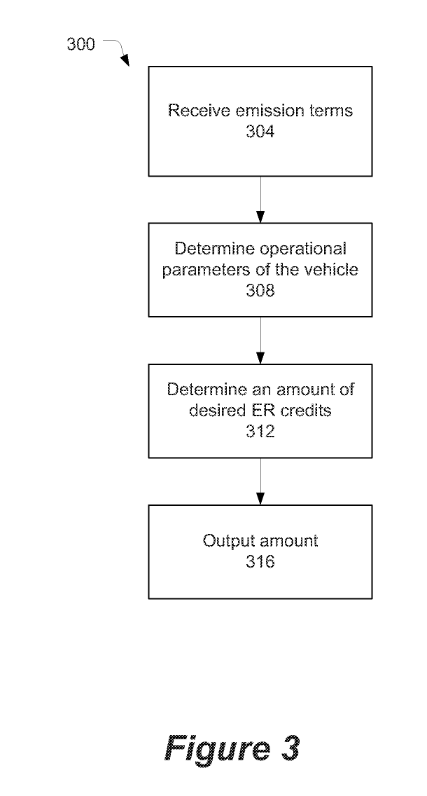

Operation of the emission manager 104 may now be described with additional reference to flowchart 300 shown in FIG. 3 in accordance with some embodiments. At block 304, the emission manager 104 may receive the emission terms, including the VIN, from the source module 120. While embodiments of this disclosure will often refer to the VIN as being the vehicle identifier, other identifiers that uniquely identify a particular vehicle, e.g., a serial number, may be used.

At block 308, the VIN decoder 128 may determine operational parameters of the vehicle based on the VIN received from the source module 120. In some embodiments, this may be done by the VIN decoder 128 constructing and transmitting a query, which includes the VIN, to the VIN repository 112. The query may be transmitted over a public network, e.g., if the VIN repository 112 is maintained by another party, or over a local connection. The VIN repository 112 may provide a response to the query, the response including operational parameters that relate to the vehicle identified by the VIN. In some embodiments, the VIN repository 112 may determine operational parameters from a public entity (e.g., the Environmental Protection Agency) or a private entity. The operational parameters may include, but are not limited to, an estimated fuel economy (e.g., highway, city, and/or combined miles per gallon (MPG) estimates), fuel type (e.g., gasoline, gasoline with ethanol (e.g., E85), diesel, diesel with biodiesel (e.g., B2, B5, B20, B99, etc.), biodiesel, straight veggie oil (SVO)), engine characteristics (e.g., engine size), drive characteristics (e.g., all-wheel drive, 2-wheel drive, 4-wheel drive).

In some embodiments, the emission terms may include additional information that may be used to adjust the operational parameters. For example, a user may be given the opportunity to provide details about an expected mix of city and highway driving; to provide details about driving style (e.g., aggressive driving style or conservative driving style), etc. This information may be used by the emission manager 104 to adjust the operational parameters, e.g., the estimated fuel economy, received from the VIN repository 112.

At block 312, the VIN calculator 124 may determine an amount of desired ER credits that achieve the offset target based on the operational parameters. The amount of desired ER credits may be in terms of the costs of the desired ER credits and/or weight of the offset emissions.

In determining the desired ER credits, the VIN calculator 124 may first compute a total GHG emissions (TGE) value, in grams, for the ECTD by the following equation.

TGE=(C/FE+N+M+H)*ECTD Equation 1

where C is a carbon factor in units of grams of carbon dioxide (CO2) per gallon of fuel; FE is a fuel economy estimate for the vehicle in units of MPG; N is a CO2 equivalent of nitrous oxide (N2O) emissions per mile; M is a CO2 equivalent of methane (CH4) emissions per mile; H is a CO2 equivalent of hydrofluorocarbon (HFC) (and miscellaneous non-tailpipe) emissions per mile; and ECTD is in units of miles. The carbon factor may be equal to approximately 8808 grams per gallon of gasoline; approximately 10,079 grams per gallon of diesel; and approximately 6252 grams per gallon of E85.

The use of the CO2 equivalent for N2O, CH4, and HFC emissions may be done in an attempt to normalize each of these emissions, given the fact that each emission is associated with a different impact on global warming. The CO2 equivalent of these emissions may be determined by multiplying their specific emission profile by a relative global warming potency factor. In some embodiments, N may be set to 1.6 grams per mile; M may be set to 0.4 grams per mile; and H may be set to 21 grams per mile.

While CO2, N2O, and CH4 are tailpipe emissions output by all internal combustion engines, HFCs are non-tailpipe emissions that result from leakage and maintenance of a vehicle's air-conditioning system. Accordingly, H may be set to 2 grams per mile (to account for miscellaneous non-tailpipe emissions) in Equation 1 if the vehicle does not include an air-conditioning system.

After determining the TGE, the VIN calculator 124 may interface with the ER credit cost module 208 of the credits bank 116 to determine a per-credit cost for the desired ER credits. The VIN calculator 124 may then multiply the per-credit cost by the TGE in order to determine a total ER credit cost that will account for the TGE.

In some embodiments, e.g., as a dealer-incentive, a certain amount of ER credits may be included in the transaction. For example, the dealer may dedicate ER credits that correlate to one ton of GHG emissions. Thus, the amount of purchased ER credits can be reduced by this amount. In some embodiments, the emission manager 104 may indicate an ECTD that correlates to the dedicated amount of ER credits as an intermediary and/or final output. As will be understood, the ECTD that correlates to the dedicated amount of ER credits will be based on the operational parameters of the vehicle.

At block 316, the amount of the desired ER credit, which, as discussed above, may include costs of the desired ER credit and/or weight of the offset emissions (i.e., the TGE), may be provided to the source module 120 and output in the output field 148. The costs of the desired ER credits may be output as a single amount and/or as an amount added to a periodic payment that also includes other financing costs of the vehicle.

Once a contract for purchasing the ER credits is executed, the purchased ER credits may be removed from the available ER credits module 216 and a new record may be created in the allocated ER credits module 224. In an embodiment in which the ER credits were not pre-purchased, the credits bank 116 may also generate and issue a purchase order to the environmental registry to affect a purchase of the desired ER credits. This may also be done external to the system 100.

The new record created in the allocated ER credits module 224 may be populated with information about the ER credits (e.g., amount, type, project source, etc.), date of the transaction, VIN, and the projected ECT term. The projected ECT term may include the value of the odometer reading input at the time of the transaction and the distance that corresponds to the purchased ER credits, which may equal the desired ECTD. These values may be summed and/or stored separately.

The source module 120 may be provided with the record information, which may be issued, to the purchaser of the vehicle, in the form of a certificate that is displayed in output field 148, printed, forwarded, etc.

While embodiments of this disclosure discuss the implementation of the system 100 in a DMS in the context of a vehicle purchase, other embodiments may implement the system 100 in other contexts. For example, the source module 120 may be part of management systems implemented by service stations, rental car agencies, department of motor vehicles, etc. Furthermore, in some embodiments, the source module 120 may be a web-based module that solicits information, e.g., by transmitting HTML messages, directly from a vehicle owner over a network.

Embodiments of the present disclosure also provide for monitoring and updating of the ECT term as will now be described.

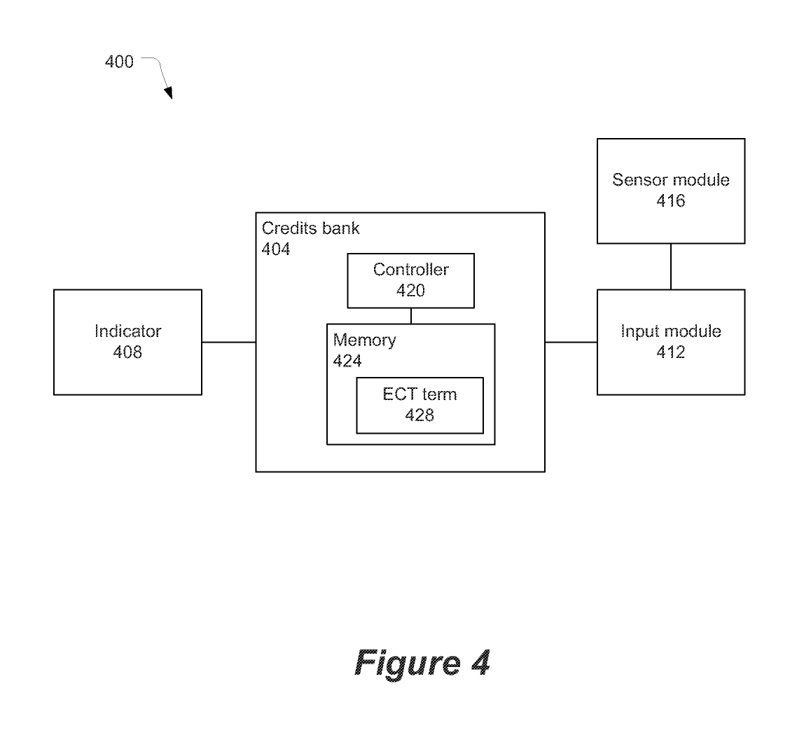

FIG. 4 illustrates a system 400 in accordance with another embodiment of the present invention. In this embodiment, a credits bank 404 may be coupled to an indicator 408 and an input module 412. The input module 412 may be coupled to a sensor module 416. The credits bank 404 may include a controller 420 coupled to memory 424, which may include volatile and/or non-volatile memory. The memory 424 may store an ECT term 428.

In some embodiments, the system 400 may be incorporated into the system 100 with the credits bank 404 including some or all of the components of credits bank 116; however, in other embodiments, the system 400 may be independent of the system 100.

As discussed above, the ECT term 428 is based on estimated total emissions (e.g., TGE). In this embodiment, the controller 420 may receive, from the input module 412, emissions data based on actual operation of the vehicle over time. The controller 420 may then use this emissions data to update the ECT term 428 and the indicator 408 may provide a user with information as to the status of the ECT term 428.

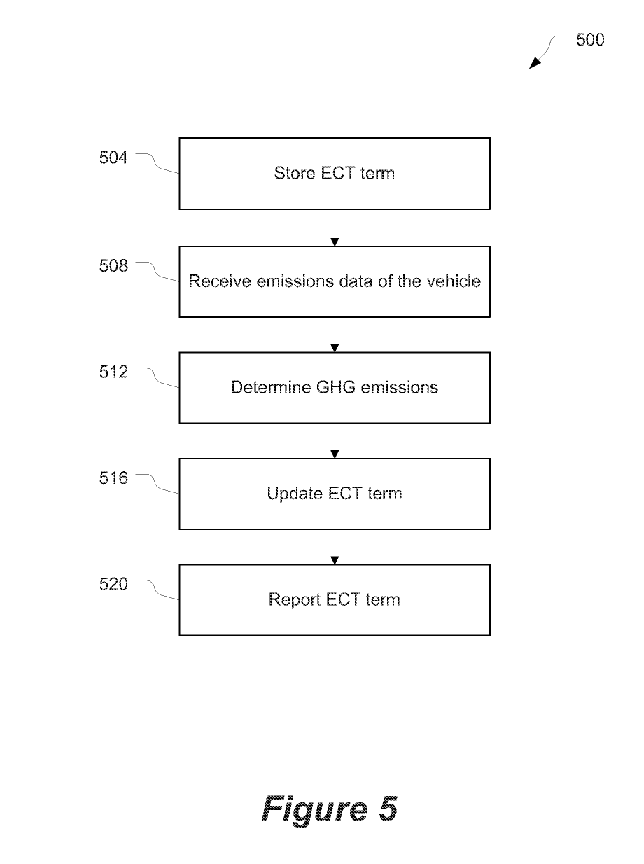

Operation of the system 400 will be described with additional reference to flowchart 500 shown in FIG. 5 in accordance with an embodiment.

At block 504, the controller 420 may store an ECT term 428 in the memory 424. At least initially, this ECT term 428 may be the projected ECT term from an initial purchase of the vehicle as described above.

At block 508, the controller 420 may receive emissions data of the vehicle from the input module 412. The sensor module 416, coupled with the input module 412, may include one or more sensors configured to measure emissions data over time. The emissions data may be a direct measurement of GHGs emitted by the vehicle and/or a measurement of parameters that may be used in the calculation of GHG emissions, e.g., fuel economy. The sensor module 416 may be implemented in, or coupled with, a vehicle's onboard computer system. This emissions data may be provided to the input module 412, and thereafter to the controller 420, on-demand, upon an occurrence of a pre-defined event, periodically, or continuously.

While FIG. 4 illustrates the sensor module 416 being coupled directly with the input module 412, in other embodiments, there may be no coupling between these two elements. For example, data may be extracted from the sensor module 416 located in a vehicle by a mechanic, technician, owner, etc. and then manually entered into the input module 412.

In some embodiments, the sensor module 416 may be maintained and operated by a third party testing facility, e.g., Department of Environmental Quality (DEQ). Results of the DEQ testing may be entered into the input module 412.

At block 512, the controller may determine GHG emissions based on the emissions data received from the input module 412. While still an estimate of GHG emissions, the GHG emissions determined at block 512, based on the emissions data, may be considered to be more accurate than an original estimate based on operational parameters received from the VIN repository 112.

In embodiments in which the emissions data indicates an emissions output at a point in time, e.g., testing at a DEQ, rather than cumulative emissions over an extended time period, the discrete emissions data may be extrapolated, by the controller 420, over an appropriate time period.

At block 516, the controller 420 may update the ECT term 428 based on the GHG emissions determined at block 512. The ECT term 428 may be extended or shortened based on the updated emissions data provided to the controller 420 from the input module 412.

At block 520, the controller 420 may report the ECT term 428 to the indicator 408. The indicator 408 may then provide a user with an indication of a status of the ECT term 428. In some embodiments, the indicator 408 may provide an alert when the ECT term 428 falls below a predetermined threshold. In other embodiments, the indicator 408 may provide a periodic report or constant status report of the ECT term 428.

The indicator 408 may be configured to provide the user with an indication of a status of the ECT term 428 in any number of ways. For example, in one embodiment, the indicator 408 may be configured to send an alert message to the user over a network. This alert message may be sent as an email message, an HTML message, a short message service (SMS) message, a multimedia message service (MMS) message, etc. In other embodiments, the indicator 408 may be configured to provide an in-vehicle indication to the user, e.g., by controlling a display within the vehicle. This may allow a user to continually monitor the ECT term 428 and/or to be alerted to an upcoming expiration of the ECT term 428.

In some embodiments, the credits bank 404 may receive, e.g., from the input module 412 and/or the source module 120, an indication of an allocation of additional ER credits to the vehicle. The controller 420 may thereafter increase the ECT term 428 accordingly.

As will be understood, the various components of the system 400 may be implemented in a variety of environments. For example, the entire system 400 may be implemented within a vehicle in one embodiment. In other embodiments some or none of the components are implemented within the vehicle. In some embodiments, the credits bank 404 may be a central server and the input module 412 may be configured to solicit a response from a remote point of contact, e.g., service station, automotive repair station, etc. This may be done by the input module 412 sending a message, e.g., an HTML message, to the remote point of contact. In other embodiments, the point of contact may include the input module 412 operating as an agent on the point of contact computer system. In this embodiment, the input module 412 may initiate contact with the credits bank 404 over the network. As will be understood, these and other embodiments are contemplated within the teachings of this disclosure.

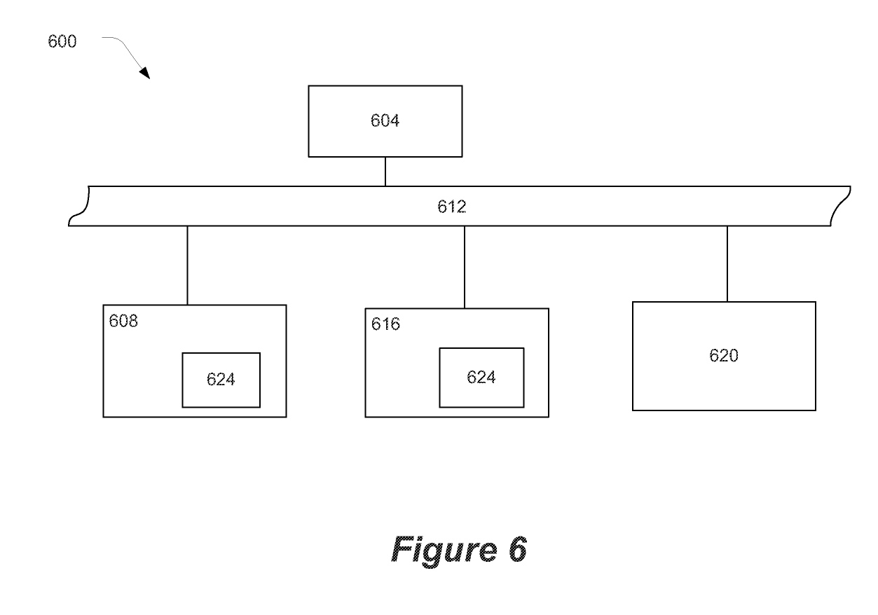

FIG. 6 illustrates a computing system 600 capable of implementing the system 100, system 400, or individual components thereof in accordance with various embodiments. As illustrated, for the embodiments, computing system 600 includes processor 604, memory 608, and bus 612, coupled to each other as shown. Additionally, computing system 600 includes storage 616, and communication interfaces 620, e.g., a network interface card (NIC), coupled to each other, and the earlier described elements as shown.

Memory 608 and storage 616 may include, in particular, temporal and persistent copies of emission logic 624, respectively. The emission logic 624 may include instructions that when executed by the processor 604 result in the various operations described herein.

In various embodiments, the memory 608 may include random access memory (RAM), dynamic RAM (DRAM), static RAM (SRAM), synchronous DRAM (SDRAM), dual-data rate RAM (DDRRAM), etc.

In various embodiments, the processor 604 may include one or more single-core processors, multiple-core processors, controllers, application-specific integrated circuits (ASICs), etc.

In various embodiments, storage 616 may be a machine-accessible medium that includes integrated and/or peripheral storage devices, such as, but not limited to, disks and associated drives (e.g., magnetic, optical), universal serial bus (USB) storage devices and associated ports, flash memory, read-only memory (ROM), nonvolatile semiconductor devices, etc.

In various embodiments, storage 616 may be a storage resource physically part of the computing system 600 or it may be accessible by, but not necessarily a part of, the computing system 600. For example, the storage 616 may be accessed by the system 600 over a network via the communication interfaces 620.

In various embodiments, computing system 600 may have more or less components, and/or different architectures.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments illustrated and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A method comprising:
receiving, from a source module, an emission offset target and an identifier, which uniquely identifies a vehicle;
determining, with a decoder, operational parameters of the vehicle based on the identifier;
determining an amount of desired emission reduction credits that achieves the offset target based on the operational parameters; and
outputting the amount.

2. The method of claim 1, wherein the identifier is a vehicle identification number.

3. The method of claim 1, wherein the source module is a dealership management system.

4. The method of claim 1, wherein said determining the operational parameters includes:
transmitting a request including the identifier to a vehicle identifier repository; and
receiving a response to the request, the response including a fuel type of the vehicle and an estimated fuel economy of the vehicle.

5. The method of claim 4, wherein said emission offset target includes a distance and said determining the amount of desired emission offsets comprises:
calculating an emissions estimate for the vehicle travelling the distance, wherein said calculating is based on the fuel type and the estimated fuel economy.

6. The method of claim 1, further comprising:
allocating emission reduction credits to the vehicle in a record of an allocated emission reduction credits module.

7. The method of claim 6, further comprising:
receiving a request, from a computing device, that includes the identifier; and
providing, to the computing device, information related to the allocated emission reduction credits based on said receiving of the request.

8. The method of claim 7, wherein said providing information comprises:
providing project information related to a project that resulted in the allocated emission reduction credits.

9. The method of claim 1, further comprising:
receiving, from the source module, a project selection that includes a selection of a project and/or a project type from which emission reduction credits are desired.

10. A system comprising:
a source module configured to receive emissions data from a user, the emissions data to include a vehicle identifier that uniquely identifies a vehicle and an emissions offset target; and
an emission manager coupled with the source module, the emission manager including
a decoder configured to determine operational parameters of the vehicle based on the vehicle identifier; and
a calculator configured to determine an amount of emissions that corresponds to the emissions offset target based on the operational parameters.

11. The system of claim 10, further comprising:
a credits bank coupled with the emission manager and configured to provide the calculator with a first cost associated with an emission reduction credit.

12. The system of claim 11, wherein the calculator is further configured to:
determine a second cost based on the first cost and the amount of emissions; and
provide the second cost to the source module.

13. The system of claim 10, further comprising:
an allocated credits module, coupled with the emission manager, and configured to have a record associating the VIN with emission reduction credits allocated to the vehicle.

14. The system of claim 13, further comprising:
a user interface, coupled with the allocated credits module, and configured to provide a user with network access to the allocated credits module.

15. The system of claim 13, wherein the record is further configured to include a projected travel distance that correlates to the allocated emission reduction credits.

16. The system of claim 10, further comprising:
an available credits module, coupled with the emission manager, and configured to provide the emission manager with information related to available emission reduction credits.

17. A method comprising:
storing, in a memory, an emission-compensated travel term associated with a vehicle;
receiving, by an input module, emissions data of the vehicle, the emissions data based on measurements of fuel economy and/or emissions of the vehicle;
determining an emissions estimate for the vehicle based on the emissions data; and
updating the emission-compensated travel term of the vehicle based on the emissions estimate.

18. The method of claim 17, further comprising:
providing an indication to a user of a status of the emission-compensated travel term.

19. The method of claim 18, wherein said providing an indication includes:
controlling a display within the vehicle.

20. The method of claim 18, wherein said providing an indication includes:
sending a message to the user over a network.

21. The method of claim 17, further comprising:
measuring, with one or more sensors of a sensor module, the fuel economy and/or emissions of the vehicle; and
providing the emissions data to the input module based on said measuring.

22. A system comprising:
an input module configured to receive emissions data of a vehicle, the emissions data based on measurements of fuel economy and/or emissions of the vehicle; and
a credits bank having a memory and a controller, coupled with the memory and the input module, and configured to store and maintain an emission compensated travel term in the memory based on the emissions data.

23. The system of claim 22, further comprising:
a sensor module coupled with the input module and having one or more sensors configured to measure the fuel economy and/or the emissions of the vehicle and to provide the emissions data to the input module based on the measured fuel economy and/or emissions.

24. The system of claim 22, further comprising:
an indicator coupled with the controller and configured to provide a user with an indication of a status of the emission compensated travel term.

25. The system of claim 24, wherein the indicator comprises a display in the vehicle.
